(19) United States
(12) Patent Application Publication
(10) Pub. No.: US 2008/0042904 A1
(43) Pub. Date: Feb. 21, 2008

(54) PLANAR ANTENNA

(75) Inventor: YEN-YI SHIH, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/611,151

(22) Filed: Dec. 15, 2006

(30) Foreign Application Priority Data
Aug. 18, 2006 (TW) 95130446

(51) Int. Cl. H01Q 1/38

(52) U.S. Cl. 343/700 MS; 343/702

(57) ABSTRACT

A planar antenna (10) includes a feed wire (14), a radiation part (18), a matching part (16), and a ground portion (12). The feed wire is used for feeding electromagnetic signals. The radiation part is connected to the feed wire for radiating electromagnetic signals, and the radiation part includes a first radiation part (180) and a second radiation (182) part connected to the first radiation part. The matching part is connected to the radiation part, and is used for impedance matching. The ground portion surrounds the feed wire, and is electronically connected to the matching part.

### BACKGROUND OF THE INVENTION

1. Field of the Invention

The invention relates to a planar antenna, and particularly to a planar antenna disposed on a substrate in a wireless local area network (WLAN) device.

2. Description of Related Art

Growing demands in the mobile communication industry stimulate quick developments in mobile communication technology. Code division multiple access (CDMA) technology is one such technology, and becomes more popular due to large traffic volume and its better communication quality.

To meet market expectations, mobile phones with CDMA technology should be designed ever smaller. Antennas are key elements of mobile phones and must be considered in any effort to reduce the size of mobile phones.

However, common antennas employed by mobile phones are planar inverted-F antennas with a pogo pin, which are rather expensive, and are not easily reduced in size.

### SUMMARY OF THE INVENTION

One aspect of the invention provides a planar antenna, which includes a feed wire, a radiation part, a matching part, and a ground portion. The feed wire is used for feeding electromagnetic signals. The radiation part is connected to the feed wire for radiating electromagnetic signals, and the radiation part includes a first radiation part and a second radiation part connected to the first radiation part. The matching part is connected to the radiation part, and is used for impedance matching. The ground portion surrounds the feed wire, and is electronically connected to the matching part.

Another aspect of the invention provides a planar antenna, which includes a feed wire, a radiation part, a matching part, and a metal ground portion. The feed wire is formed on an insulative area of a substrate, and is used for feeding electromagnetic signals. The radiation part is connected to the feed wire, and is used for radiating electromagnetic signals, and includes a plurality of radiation segments. The matching part is connected to the radiation part for impedance matching. The metal ground portion is connected to the matching part.

The radiation part is parallel to the ground portion, and is formed with by metallic line instead of pogo pins, thereby, minimizing the profile of the planar antenna.

Other advantages and novel features will become more apparent from the following detailed description when taken in conjunction with the accompanying drawings, in which:

### BRIEF DESCRIPTION OF THE DRAWINGS

FIG. 1 is a schematic view of a planar antenna of an exemplary embodiment of the present invention;

FIG. 2 is a dimensional schematic view of a planar antenna of FIG. 1;

FIG. 3 is a graph of test results showing return loss of the planar antenna of FIG. 1; and

FIG. 4 to FIG. 6 are graphs of test results showing radiation patterns when the planar antenna of FIG. 1 is operated at 860 MHz.

### DETAILED DESCRIPTION OF THE INVENTION

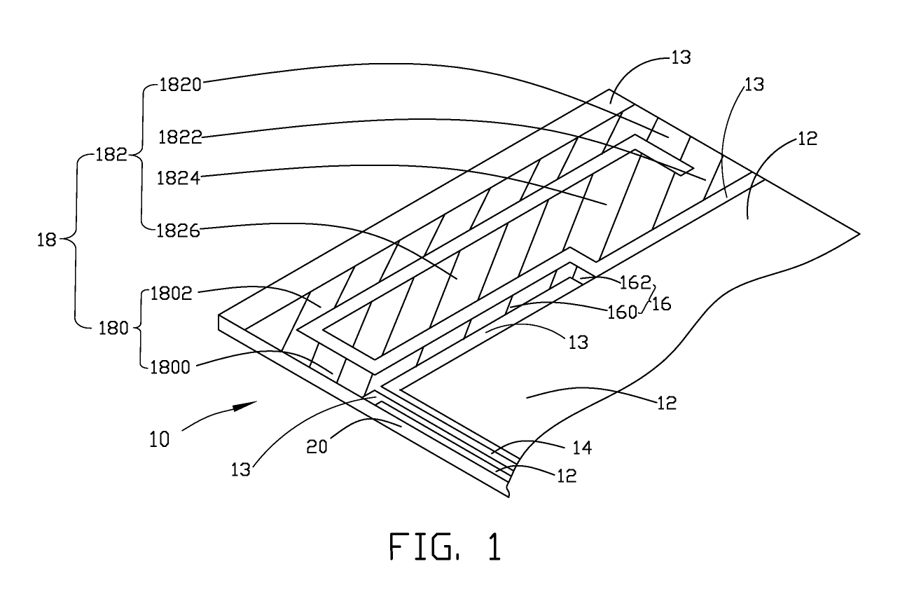

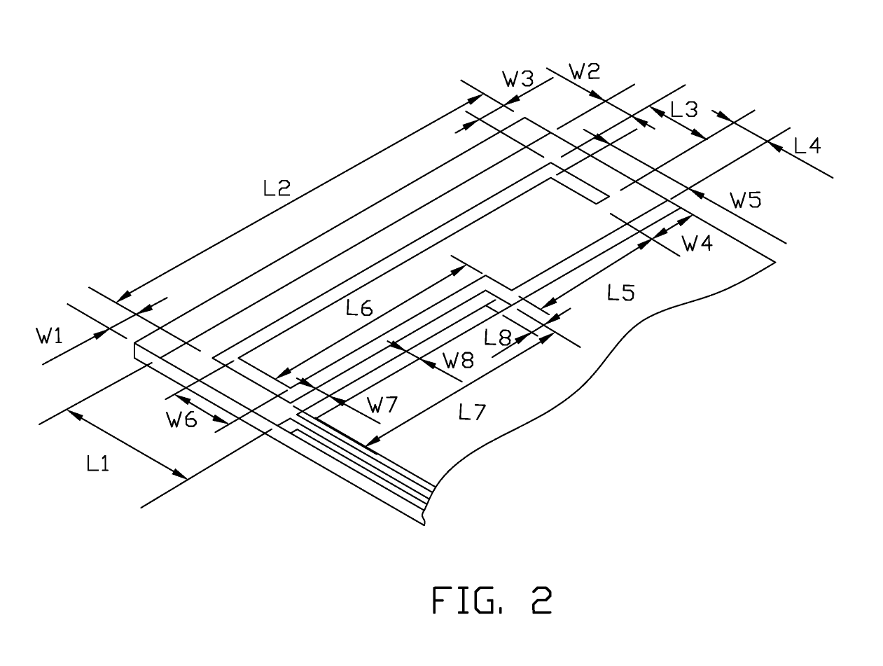

FIG. 1 is a schematic view of a planar antenna 10 of an exemplary embodiment of the present invention. In the exemplary embodiment, the planar antenna 10 includes a feed wire 14, a radiation part 18, and a matching part 16. The feed wire 14 is formed on a substrate 20, and is used for feeding electromagnetic signals, and one end of the feed wire 14 is connected to the radiation part 18. In the exemplary embodiment, a resistance of the feed wire 14 is 50 ohms. In the exemplary embodiment, the substrate 20 is a printed circuit board (PCB), and includes a metal area 12 and an insulative area 13. The metal area 12 is provided as a ground portion for the antenna 10. The feed wire 14, the radiation part 18, and the matching part 16 are formed in the insulative area 13. In the exemplary embodiment, the metal area 12 is disposed on two sides of the feed wire 14.

In the exemplary embodiment, the radiation part 18 is located on the insulative area 13, and is used for radiating electromagnetic signals, and includes a first radiation part 180 and a second radiation part 182.

The first radiation part 180 includes a first radiation segment 1800 and a second radiation segment 1802. One end of the first radiation segment 1800 is connected to the feed wire 14, and the other end of the first radiation segment 1800 is perpendicularly connected to one end of the second radiation segment 1802. In the exemplary embodiment, the feed wire 14 and the first radiation segment 1800 are located on a same line.

The second radiation part 182 includes a third radiation segment 1820, a fourth radiation segment 1822, a fifth radiation segment 1824, and a sixth radiation segment 1826. One end of the third radiation segment 1820 is perpendicularly connected to the other end of the second radiation segment 1802, that is, the third radiation segment 1820 is parallel to the first radiation segment 1800.

One end of the fourth radiation segment 1822 is perpendicularly connected to the other end of the third radiation segment 1820, that is, the fourth radiation segment 1822 is parallel to the first radiation segment 1800. One end of the fifth radiation segment 1824 is perpendicularly connected to the other end of the fourth radiation segment 1822, that is, the fifth radiation segment 1824 is parallel to the third radiation segment 1820, the first radiation segment 1800, and the second radiation segment 1802.

One end of the sixth radiation segment 1826 is connected to the fifth radiation segment 1824, the other end of the sixth radiation segment 1826 is a free end. In other words, the sixth radiation segment 1826 is parallel to the second radiation segment 1802. The width of the sixth radiation segment 1826 is larger than the width of the first radiation segment 1800, the second radiation segment 1802 or the third radiation segment 1820.

In the exemplary embodiments, the adjacent segments, such as the first radiation segment 1800 is perpendicular to the second radiation segment 1802, the third radiation segment 1820 is perpendicular to the second radiation segment 1802, the fourth radiation segment 1822 is perpendicular to the third radiation segment 1820, the fifth radiation segment 1824 is perpendicular to the fourth radiation segment 1822, and the sixth radiation segment 1826 is perpendicular to the fifth radiation segment 1824. The sixth radiation segment 1826 is arranged to be cooperatively surrounded by at least the first radiation segment 1800, the second radiation segment 1802, the third radiation segment 1820 and the matching part 16.

The matching part 16 is also configured in the insulative area 13, and is electronically connected to the radiation part 18 and the metal area 12 for impedance matching. The matching part 16 includes a first matching segment 160 and a second matching segment 162. One end of the first matching segment 160 is electronically connected to the first radiation segment 1800, the other end of the first matching segment is connected to one end of the second matching segment 162, and the other end of the matching segment 162 is electronically connected to the edge of the metal area 12. The second radiation segment 1802 and the sixth radiation segment 1826 are respectively parallel to the first matching segment 160. In the exemplary embodiment, the first matching segment 160 is perpendicular to the second matching segment 162 and the first radiation segment 1800. The second matching segment 162 is perpendicular to the edge of the metal area 12. In alternative exemplary embodiments, the first matching segment 160 and the second matching segment 162 also form other angles therebetween, the first matching segment 160 and the first radiation segment 1800 also form other angles therebetween, the first radiation segment 1800 and the fifth radiation 1824 respectively also form other angles with the second radiation segment 162.

In the exemplary embodiment, the first radiation segment 1800, the second radiation segment 1802, the third radiation segment 1820, the fourth radiation segment 1822, the fifth radiation segment 1824, the sixth radiation segment 1826, the first matching segment 160, and the second matching segment 162 are all strip shaped.

In the exemplary embodiment, a length L1 and a width W1 of the first radiation segment 1800 are respectively 10 mm and 2 mm. A length L2 and a width W2 of the second radiation segment 1802 are respectively 28 mm and 2 mm. A length L3 and a width W3 of the third radiation segment 1820 are respectively 3.5 mm and 2 mm. A length L4 and a width W4 of the fourth radiation segment 1822 are respectively 3.5 mm and 3 mm. A length L5 and a width W5 of the fifth radiation segment 1824 are respectively 9 mm and 6 mm. A length L6 and a width W6 of the sixth radiation segment 1824 are respectively 15 mm and 4 mm. A length L7 and a width W7 of the first matching segment 160 are respectively 15 mm and 1 mm. A length L8 and a width W8 of the second matching segment 162 are respectively 1 mm and 1 mm.

In alternative exemplary embodiments, lengths and widths of elements of the planar antenna 10 can be changed.

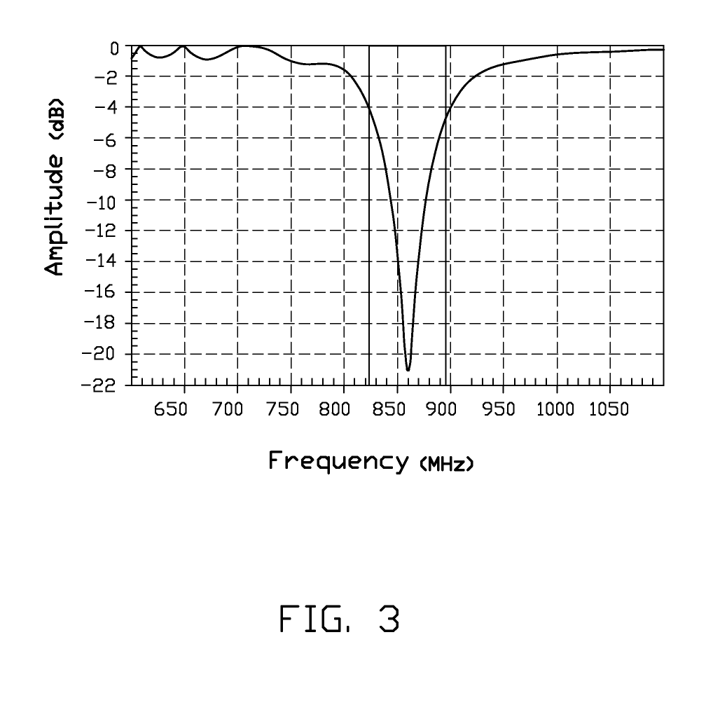

FIG. 3 is a graph of test results showing return loss of the planar antenna 10 of FIG. 1. As shown, when the planar antenna 10 operates at working frequency bands of 824˜894 MHz, its return loss is less than −4 dB. This indicates that the working frequency of the planar antenna 10 covers the frequency bands of the code division multiple access (CDMA) technology.

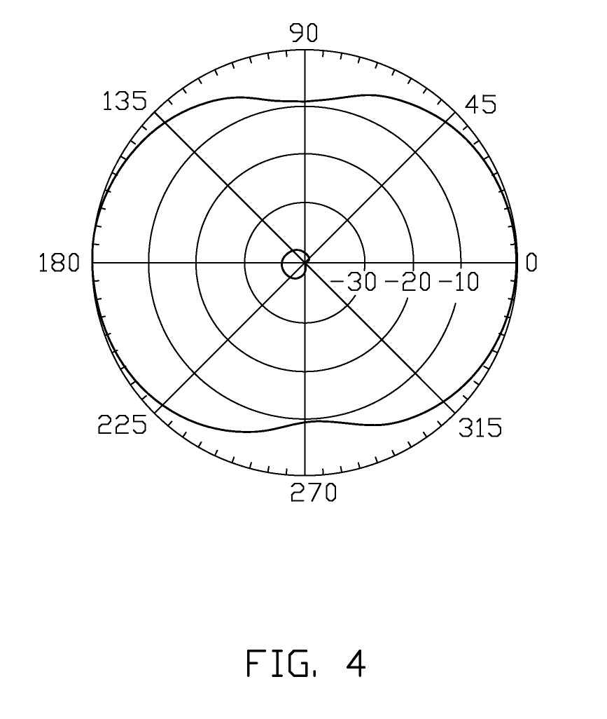

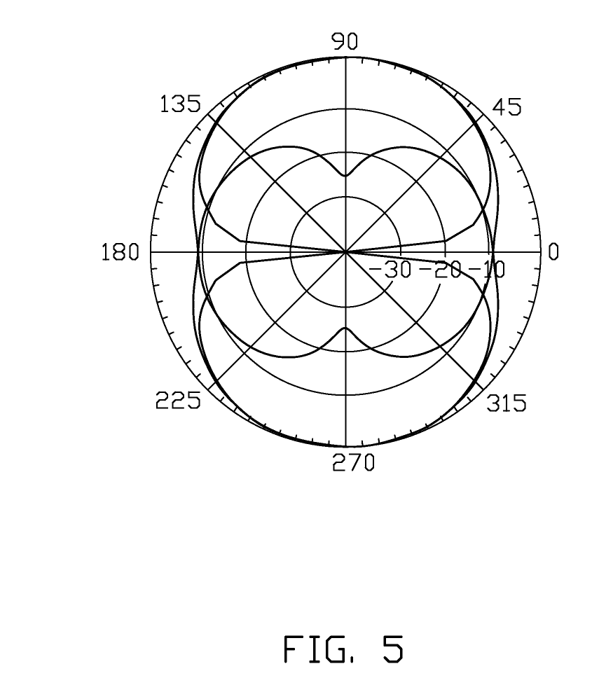

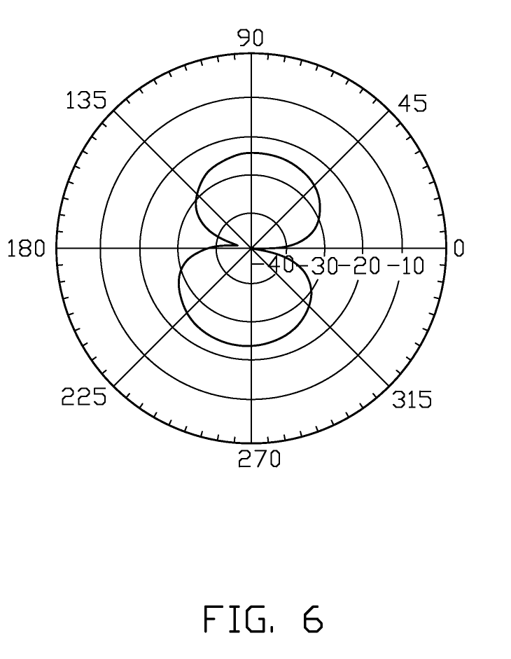

FIG. 4 to FIG. 6 are graphs of test results showing a radiation pattern when the planar antenna 10 of FIG. 1 operates at 860 MHz.

In the exemplary embodiment, the radiation part 18 is parallel to ground, and is formed by a metallic line instead of by pogo pins, thereby, minimizing the profile of the planar antenna 10.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A planar antenna formed on a substrate, the planar antenna comprising:
a feed wire for feeding electromagnetic signals;
a radiation part connected to the feed wire for radiating electromagnetic signals, the radiation part comprising a first radiation part and a second radiation part connected to the first radiation part;
a matching part connected to the radiation part, for impedance matching; and
a ground portion surrounding the feed wire, and electronically connecting with the matching part.

2. The planar antenna of claim 1, wherein the first radiation part comprises a first radiation segment and a second radiation segment, the first radiation segment connecting to the matching part and the feed wire, the second radiation segment perpendicularly connecting to the first radiation segment.

3. The planar antenna of claim 2, wherein the feed wire and the first radiation segment are located on a same line.

4. The planar antenna of claim 2, wherein the matching part comprises a first matching segment and a second matching segment, the first matching segment connecting to the first radiation segment, the second matching segment connecting to the first matching segment and the ground portion.

5. The planar antenna of claim 4, wherein the first matching segment is perpendicular to the first radiation segment, and the second matching segment is parallel to the first radiation segment.

6. The planar antenna of claim 2, wherein the second radiation part comprises a third radiation segment, a fourth radiation segment, a fifth radiation segment, and a sixth radiation segment, the fourth radiation segment connecting to the third radiation segment and the fifth radiation segment, the fifth radiation segment connecting to the sixth radiation segment.

7. The planar antenna of claim 6, wherein the third radiation segment is parallel to the first radiation segment and the fifth radiation segment, and the fourth radiation segment is parallel to the second radiation segment.

8. The planar antenna of claim 6, wherein the third radiation segment is perpendicular to the second radiation segment and the fourth radiation segment, and the fifth radiation segment is perpendicular to the fourth radiation segment and the sixth radiation segment.

9. A planar antenna formed on a substrate, comprising:
a feed wire formed on an insulative area of the substrate, for feeding electromagnetic signals;
a radiation part connected to the feed wire, for radiating electromagnetic signals, comprising a plurality of radiation segments connected one by one;
a matching part connected to the radiation part for impedance matching; and
a metal ground portion connected to the matching part.

10. The planar antenna of claim 9, wherein the metal ground portion is disposed on two sides of the feed wire.

11. The planar antenna of claim 9, wherein the feed wire and the first radiation segment are located on a same line.

12. The planar antenna of claim 1, wherein the matching part comprising a first matching segment and a second matching segment, the first matching segment connecting to the first radiation segment, the second matching segment connecting to the first matching segment and an the metal ground portion.

13. The planar antenna of claim 12, wherein the second matching segment is perpendicular to the first matching segment.

14. An antenna assembly comprising:
a substrate; and
an antenna formed on said substrate, said antenna comprising a feed wire for feeding electromagnetic signals to said antenna, a radiation part electrically connectable with said feed wire and extending away from said feed wire for radiating and receiving said electromagnetic signals, a ground portion disposed on said substrate beside said feed wire, and a matching part electrically connectable between said radiation part and said ground portion for matching impedance, said radiation part comprising at least one radiation segment arranged to be cooperatively surrounded by at least two of the rest radiation segments of said radiation part and said matching part.

15. The antenna assembly of claim 14, wherein said at least one radiation segment of said radiation part comprises an extending free end.

16. The antenna assembly of claim 14, wherein a width of said at least one radiation segment of said radiation part is larger than another width of said at least two of the rest radiation segments of said radiation part.
